(19) United States
(12) Patent Application Publication
(10) Pub. No.: US 2008/0109778 A1
(43) Pub. Date: May 8, 2008

(54) Setting method of line pitch/line width layout for logic circuit

(75) Inventor: Hsiang-Yi Hsieh, Taipei (TW)

Correspondence Address: RABIN & Berdo, PC, 1101 14TH STREET, NW, SUITE 500, WASHINGTON, DC, 20005, US

(73) Assignee: INVENTEC CORPORATION, Taipei (TW)

(21) Appl. No.: 11/584,528

(22) Filed: Oct. 23, 2006

(51) Int. Cl. G06F 17/50

(52) U.S. Cl. 716/10

(57) ABSTRACT

A setting method of line pitch/line width layout for a logic circuit is provided. In the setting method, a circuit integration procedure is utilized to find the conformable circuit code and retrieve the corresponding circuit setting by string comparison from a logic circuit setting file, so as to integrally generate a first layout setting file. Then an area restriction rule is loaded for adjusting the first layout setting file in order to form a second layout file. The second layout file is transmitted to the logic circuit software. Thus, the user may rapidly obtain the circuit layout setting and uses it in the logic circuit software. Therefore, not only lots of pre-operation time can be reduced, but the situations of wrong inputting of setting value are also reduced.

### BACKGROUND OF THE INVENTION

1. Field of Invention

The present invention relates to a method of obtaining a layout setting for a logic circuit, and more particularly, to a method of analyzing the circuit information included in a logic circuit setting file to directly obtain a required circuit layout setting transmitted into the logic circuit software.

2. Related Art

Refining of electronic apparatus is the necessary trend, so how to design a circuit with the most functions in the smallest space has become an important problem. In other words, in the logic circuit manufacturing process, the circuit layout design may affect the arrangement and the occupied space of all the parts. Therefore, how to arrange the circuit becomes the primary key point.

In the current circuit design, in order to effectively manage the circuit arrangement and increase the convenience of the circuit design, the circuit setting of the circuit layout is calculated by the exclusive logic circuit software, but the setting value to be input includes the information such as the line pitch (distance between the circuits), the line width (width of the connecting line), setting of the circuit rule and the limitation of the special condition. Various kinds of circuit setting values are manually input into each setting value field of the logic circuit software firstly. After the application scope of each circuit setting value is manually analyzed, the circuit rule corresponding to the circuit setting value is selected and input, so as to accord with the requirement of the logic circuit design.

However, the conventional art has the disadvantages that cannot be avoided. The disadvantages are described as follows.

According to the current logic circuit software, all of the circuit layout settings must be input manually, and the circuit rule also must be analyzed manually before being input and selected. However, as for designing a logic circuit, there are at least scores of connecting circuits. If the circuit function is huge and complicated, hundreds or thousands of corresponding connecting circuits may exist, only the setting value required to be input by each circuit may be more than one. Accordingly, at least scores of and at most thousands of circuit setting values must be input. Therefore, the possibility of the error input of the setting value is quite high. If a data is input in error, it is not easy to inspect where the error is, thus it is difficult to generate the correct circuit testing output.

In the conventional art, the quantity of the circuit setting values to be input is numerous, and it is done by manual work, thus is quit time consuming. If the setting of the circuit rule is added, and the circuit rule suitable for the circuit is analyzed, usually two to three days are cost before starting to perform the logic circuit test. For the pre-operation, the time cost is too high.

### SUMMARY OF THE INVENTION

Accordingly, in order to solve the problems of the conventional art, increase the convenience for the user, and simplify the logic circuit design flow to increase the production efficiency, the present invention provides a setting method of line pitch/line width layout for logic circuit.

The present invention relates to a setting method of line pitch/line width layout for logic circuit, which applies a logic circuit setting file to directly generate the layout setting that may be transmitted to the logic circuit software, and the logic circuit software may be the logic circuit designing software Allegro commonly used by the people in the industry. The logic circuit software firstly outputs a logic circuit setting file comprising the setting values required by the logic circuit designing, such as, the circuit codes (number corresponding to each circuit), the line pitch (distance between two neighboring circuits)/line width (line width used by each circuit) setting information corresponding to the circuit codes. According to a coding rule, a circuit integration procedure is used to obtain a plurality of circuit codes comprised in the logic circuit setting file by string comparison step by step, and to obtain a plurality of line pitch/line width settings respectively corresponding to the circuit codes by the same manner. Information integration is performed for all of the above information, that is, the circuit integration procedure is used to obtain the best circuit setting of the logic circuit by a circuit comparing rule, and the comparison result is stored to form a first layout setting file. However, the first layout setting file can only preliminarily determine the preferred circuit setting, and cannot be used on the logic circuit having the special designing limitation. Thus, an area restriction rule is loaded by the circuit integration procedure, that is, all of the special design limitation information of each logic circuit in the circuit layout are record, and the circuit information comprised in the first layout setting file is adjusted step by step by the comparing procedure according to the area restriction rule, so as to form a second layout setting file. Finally, the file is transmitted into the logic circuit software, so as to perform the subsequent testing action.

The present invention is a setting method of line pitch/line width layout for logic circuit, which has the following several actions better than that of the conventional art, and has the distinct functional improvements described as follows.

1. The designing flow of the logic circuit is simplified. It is known from the conventional art that the required circuit setting values needs to be manually input in the logic circuit software. However, by the method of the present invention and the operation of the circuit integration procedure, the best circuit setting required by the logic circuit software is quickly obtained, so as to omit the operating flow of manual inputting.

2. The error rate is reduced. It is known from the conventional art that the inputting of the circuit setting value, the setting and selecting of the most appropriate circuit rule and the particular designing limitation condition are performed manually when using the previous logic circuit software, but the circuit setting values required to be input are complicated and numerous, even the inputting error is difficult to be inspected and corrected. However, according to the method of the present invention and the operation of the circuit integration procedure, all of the circuit setting values to be input may be generated with the particular rule, thereby avoiding-the man-made mistake indeed.

3. The time cost is reduced, and the designing flow of the logic circuit is simplified. It is known from the conventional art that usually the required circuit setting values need to be manually input in the logic circuit software, and there are at least scores of at most thousands of the circuit setting values, only the inputting of the setting values needs to cost two to three days. However, by the method of the present invention and the operation of the circuit integration procedure, the circuit setting values that may be transmitted into the logic circuit software can be quickly generated.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a structural view of the system of the present invention;

FIG. 2 is a flow chart of the method of the present invention;

FIG. 3 is a storing format of the logic circuit setting file of the present invention;

FIG. 4 is a simplified schematic view of the format of the first layout setting file of the present invention; and

FIG. 5 is a simplified schematic view of the format of the second layout setting file of the present invention.

### DETAILED DESCRIPTION OF THE INVENTION

In order to make a further understanding of the objective, the construction feature and the function of the present invention, it is illustrated in detail with the relative embodiments and drawings as follows.

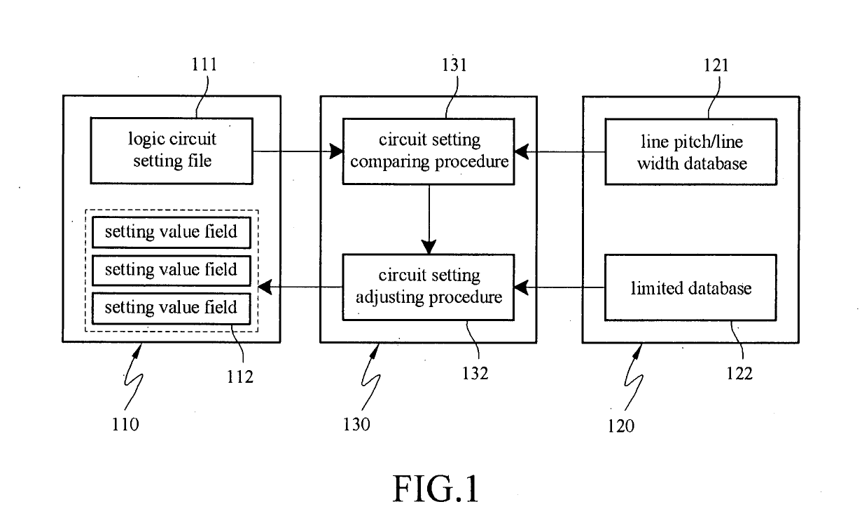

Please refer to FIG. 1 of a structural view of the system applying the method of the present invention. As shown in FIG. 1, the system of the present invention includes a logic circuit software 110, a circuit setting database 120 and a circuit integration procedure 130. The logic circuit software 110 includes a logic circuit setting file 111, and a plurality of setting value fields 112 for inputting the circuit setting. The logic circuit setting file 111 has the circuit setting information required by the logic circuit, and the circuit setting information includes the circuit code of each circuit, and the line pitch/line width setting corresponding to each circuit code primarily set by the user. The circuit setting database 120 includes a line pitch/line width database 121, which pre-stores a plurality of circuit setting pre-storing information including circuit number and a plurality of preset line pitch/line width settings corresponding to each circuit number. The circuit setting database 120 further includes a limited database 122, which pre-stores a plurality of area restriction rules. Usually the logic circuit may divide the circuit into different functional areas according to the function. According to the difference of the functional area, it is necessary for the setting of the circuit to have different limitations, and the area restriction rule sets the setting rule for the designing of the circuit. The circuit integration procedure 130 includes a circuit setting comparing procedure 131 and a circuit setting adjusting procedure 132. The circuit setting comparing procedure 131 obtains the logic circuit setting file 111, retrieves the circuit number and the line pitch/line width settings included in the logic circuit setting file 111, and connects the line pitch/line width database 121 to obtain the circuit setting pre-stored information corresponding to each circuit, so as to integrally compare and select the preferred circuit setting value, and to store it as a first layout setting file and output to the circuit setting adjusting procedure 132. The circuit setting adjusting procedure 132 is connected to the limited database 122, loads the required area restriction rule, adjusts the circuit setting value stored in the first layout setting file, and stores the circuit setting value being adjusted as a second layout setting file, so as to transmit into the logic circuit software 11, and to automatically load the corresponding circuit setting value according to the setting value field 112.

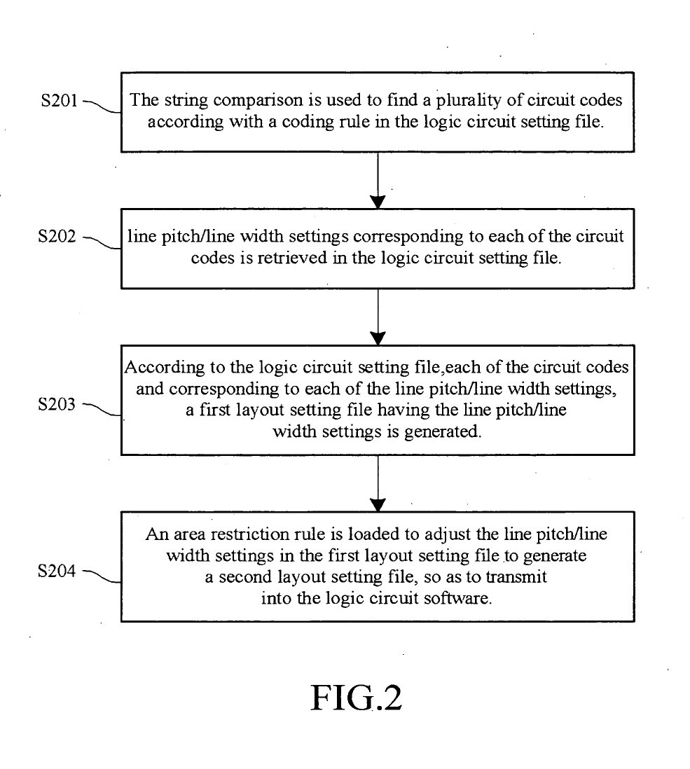

Please refer to FIG. 2 of a flow chart of the setting method of line pitch/line width layout for logic circuit according to the present invention. The method applies a logic circuit setting file to directly generate the layout setting that may be transmitted into the logic circuit software 110. In order to make an understanding of the method, please refer to FIG. 1. The method includes the following steps.

A plurality of circuit codes conforming to a coding rule is found by a string comparison from the logic circuit setting file 111 (step S201). The logic circuit software 110 firstly outputs a logic circuit setting file 111, and the circuit integration procedure 130 may load the logic circuit setting file 111. The circuit setting comparing procedure 131 is used to find all of the circuit codes by string comparison.

A plurality of line pitch/line width settings corresponding to each of the circuit codes is retrieved from the logic circuit setting file 111 (step S202), the circuit setting comparing procedure 131 uses the circuit codes as the basic string to find and obtain all of the plurality of the line pitch setting information and the line width setting information corresponding to each circuit codes. Then, the circuit setting comparing procedure 131 retrieves a plurality of pre-stored line pitch/line width settings corresponding to each circuit code information from a circuit setting database 130.

According to the logic circuit setting file 111, each of the circuit codes and corresponding to each of the line pitch/line width settings, a first layout setting file having the line pitch/line width settings are generated (step S203). The circuit integration procedure 130 firstly obtains the line pitch/line width settings from the logic circuit setting file 111, and the preset line pitch/line width settings information stored in the line pitch/line width database 130. Also, an input interface is provided for inputting the desired line pitch/line width settings recognized by the user. Next, the circuit setting corresponding to each of the circuit codes is preliminarily determined, thereby selecting the preferred line pitch/line width settings. Then, the selection result is output to form the first layout setting file and is transmitted to the circuit setting adjusting procedure 132.

An area restriction rule is loaded to adjust the line pitch/line width settings in the first layout setting file to generate a second layout setting file to be transmitted into the logic circuit software 110 (step S204). After the first layout setting file is generated, that is, after the preliminary selection of the circuit setting value, the special problems must be noted during the practical circuit design and in each functional area are not taken into consideration, such as electromagnetic interference, noise or undesired electric energy conducting because of the overhigh circuit impedance. Therefore, each functional area must be stored in the limited database 122 according to the setting rule of the designing. After the circuit setting adjusting procedure 132 obtains the first layout setting file, the required area restriction rule is loaded from the limited database 122 to the circuit setting adjusting procedure 132, and the line pitch/line width settings stored in the first layout setting file are adjusted one by one, so as to form the desired circuit setting information. The result is output to form the second layout setting file and transmitted into the logic circuit software 110, and is filled in the setting value fields 112 in sequence according to the circuit type, so as to facilitate the performing of the subsequent testing operation of the logic circuit.

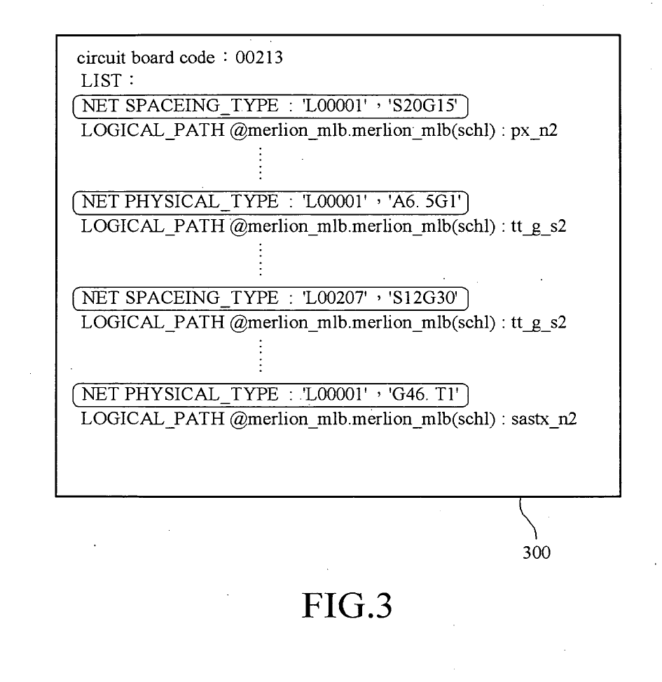

Please refer to FIG. 3 of a simplified schematic view 300 of the format of the logic circuit setting file according to the present invention. As shown in FIG. 3, “net_spacing” is used to find the line width setting, “net_physical” is used to find the line pitch setting, wherein S represents that at least how many units of length should be spaced when the line width settings are of the same group, and G represents that how many units of length should be spaced when the line width settings are of different groups. In the embodiment, “net_spacing:(S12G30)” represents that at least 12 units of length should be spaced between the same group of line pitch setting, and 30 units of length should be spaced between the different groups.

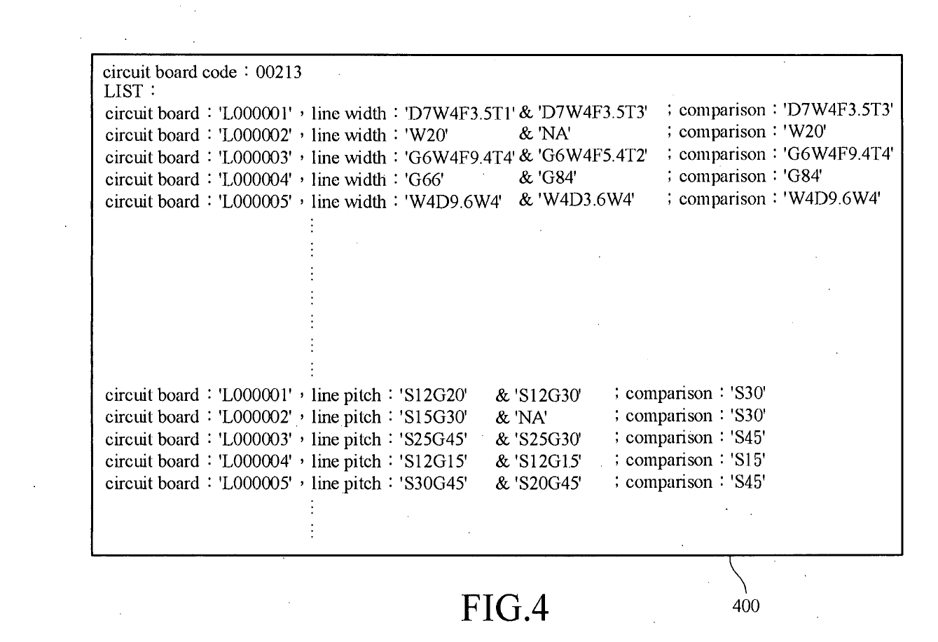

Please refer to FIG. 4 of a simplified schematic view 400 of the format of the first layout setting file according to the present invention. As shown in FIG. 4, the information formats are in sequence the circuit board, codes, the circuit code, the compared line width settings or line pitch settings, and finally the preferred line width/line pitch setting result obtained after comparison.

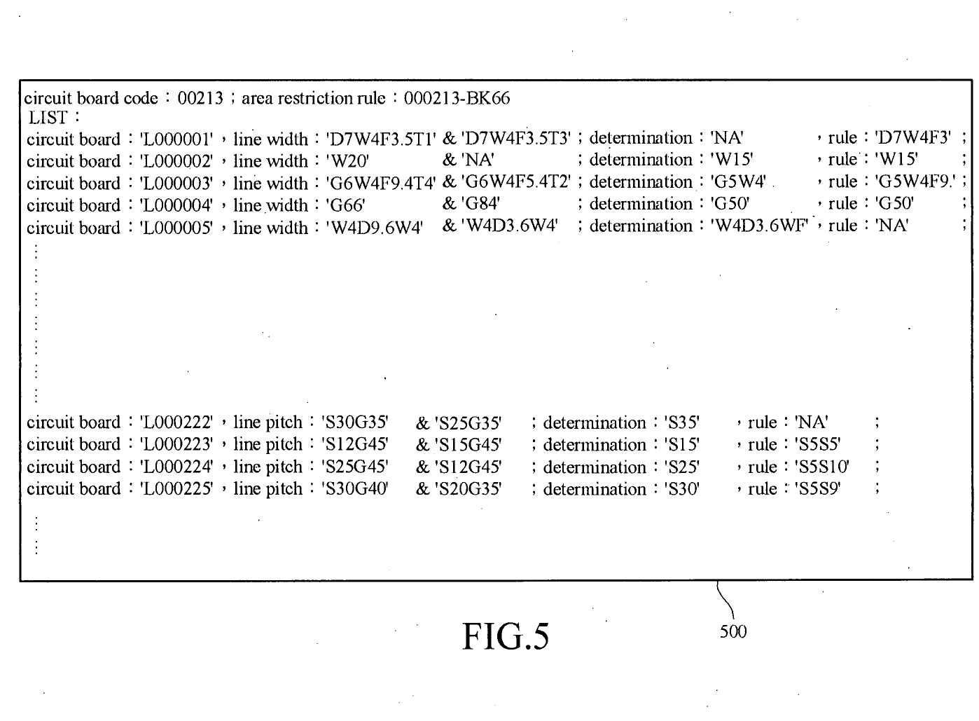

Please refer to FIG. 5 of a simplified schematic view 500 of the format of the second layout setting file according to the present invention. As shown in FIG. 5, the information formats are in sequence the circuit board codes, the used area restriction rule, the circuit codes and the line width/line pitch setting result formed by adjusting after loading the limitation rule, and the limitation condition used for forming each setting result.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A setting method of line pitch/line width layout for a logic circuit, utilizing a logic circuit setting file to directly generate a layout setting transmitted into the logic circuit software, comprising:
finding a plurality of circuit codes conforming to a coding rule by a string comparison from the logic circuit setting file;
retrieving a plurality of line pitch/line width settings corresponding to each circuit code from the logic circuit setting file;
generating a first layout setting file having the line pitch/line width settings according to the logic circuit setting file, each of the circuit codes and corresponding to each of the line pitch/line width settings; and
loading an area restriction rule to adjust the line pitch/line width settings in the layout setting file to generate a second layout setting file to be transmitted into the logic circuit software.

2. The setting method of line pitch/line width layout for a logic circuit as claimed in claim 1, wherein the step of retrieving the plurality of line pitch/line width settings corresponding to each circuit code information from the logic circuit setting file further comprises:
transmitting a plurality of pre-stored line pitch/line width settings corresponding to each circuit code information from a circuit setting database.

3. The setting method of line pitch/line width layout for a logic circuit as claimed in claim 1, wherein the step of generating a first layout setting file having the line pitch/line width settings according to the logic circuit setting file, each of the circuit codes and corresponding to each of the line pitch/line width settings further comprises:
utilizing a interface to input each of the line pitch/line width settings corresponding to each of the circuit codes.

4. The setting method of line pitch/line width layout for a logic circuit as claimed in claim 1, wherein the step of generating a first layout setting file with the line pitch/line width settings according to the logic circuit setting file, each of the circuit codes and corresponding to each of the line pitch/line width settings further comprises:
comparing each of the line pitch/line width settings corresponding to each of the circuit codes, and selecting each preferred line pitch/line width setting.
